(19) United States
(12) Patent Application Publication
(10) Pub. No.: US 2015/0298990 A1
(43) Pub. Date: Oct. 22, 2015

(54) METHOD AND SYSTEM FOR TREATING WATER INBOARD A VESSEL

(71) Applicant: ULMATEC PYRO AS, Søvik (NO)

(72) Inventor: Jan Petter Urke, Longva (NO)

(73) Assignee: ULMATEC PYRO AS, Søvik (NO)

(21) Appl. No.: 14/441,738

(22) PCT Filed: Nov. 13, 2012
(86) PCT No.: PCT/NO2012/050222

§ 371 Date: May 8, 2015

(51) Int. Cl. C02F 1/02; B63J 4/00

(52) U.S. Cl. CPC C02F 1/02; B63J 4/002; C02F 2303/04

(57) ABSTRACT

A method and a system for treating water on board a vessel before discharging such water to the sea. The water to be treated is pumped through a primary heat exchanger (12) where the water is pre-heated and then through a secondary heat exchanger (13) where the water is further heated, the secondary heat exchanger (13) being heated by thermal fluid from a central heating system primarily heated by heat recovered from different type of heat generating equipment and also possibly by fuel and/or electricity in cases where the heat recovered from the heat generating systems is not sufficient to treat the water in a sufficient manner.

### TECHNICAL FIELD OF THE INVENTION

The present invention relates to a method and a system for treating ballast and waste water onboard vessels prior to discharging such water to the sea, the system comprising a ballast water tank, one or more pumps (15) and an associated piping and valve system for transport of the water to be treated.

### BACKGROUND FOR THE INVENTION

Vessels depend on ballast water to provide stability and also maneuverability during a voyage. Such ballast water may be taken on at one port where for example cargo is unloaded and discharged to sea at another port when the vessel is loaded again.

In aqua farming or aquaculture, it is common to use transport vessels for transporting living aquatic biomass, such as salmon, in water filled tanks from production nets, cages or cultivation enclosures for example to an abattoir, either onboard a larger vessel or onshore. To facilitate such transport the living aquatic biomass is pumped from the production nets to tanks onboard the vessel in a pumping and pipe system, using water as transporting medium. Moreover, the fish is correspondingly pumped in the same manner from the tanks onboard to receiving stations at the abattoir. At the same time, such transport vessels are also used to transport for example smolt from hatch to said production nets, cages or cultivation enclosures.

The water used for ballasting and/or pumping living aquatic biomass may be infected with organisms, such as small fish, lice, bacteria, viruses or other micro-organisms. By discharging such infected waters directly to sea, detrimental and undesirable introduction and spread of non-native organisms, called bio-invaders or alien species, will occur. Further, such infested water may also be a source for the spread of detrimental and undesirable diseases or spread of lice or the like to the next generation living biomass.

In a publication named “Marine Bioinvasion fact s\Sheet: Ballast water Treatment Options”, by Corrina Chase, Christine Reilly and Judith Pederson, it is proposed to heat the ballast water in tanker vessels to between 35° C. and 45° C. by means of the cooling water from the propulsion prior to discharging the ballast water to the sea. Such temperature range is too low to kill all detrimental micro-organisms and bacteria and water temperatures within this range or above will be more prone to cause corrosion in the tank that water stored at a lower temperature.

There is a need for a method and a system which secures that ballast water discharged to sea does not contain any detrimental organisms or micro-organisms which may have a negative effect on the environment. Moreover, there is a need for a method and a system which also secures that detrimental bacteria/viruses or other organisms such as lice, are prevented from being discharged to sea when discharging the water in which the living aquatic biomass has been contained in during transport to an abattoir.

Further there is a need for a system where living aquatic biomass is not infected by bacteria/viruses or other organisms such as lice, during transport to a cultivation enclosure due to contamination of the containers or tanks used previous transport living aquatic biomass.

### SUMMARY OF THE INVENTION

An object of the present invention is to prevent in an improved manner contaminated water to be discharged to sea, including preventing distribution of detrimental biomass from vessels or other types of, such as biomass infested or infected ballast water or other type of transportation or storage water. An object of the present invention is to provide an improved method and a system which prevents contaminated water to be discharged to sea.

Another object of the present invention is to provide an improved method and system where possible infested or infected water on board a vessel is prevented from being discharged untreated to sea.

Yet another object of the invention is to remove all living biomasses in water onboard a vessel prior to discharging such infested or infected water to sea.

A still further object of the present invention is to remove such biomass by heating, wherein that is supplied from sources which otherwise would have been lost or not utilized.

Another object of the present invention is to provide a method and system for removal of detrimental biomass from water in an cost effect way.

The object of the present invention is achieved by a method and a system as further defined in the independent claims, while alternative embodiments and variants are defined by the dependent claims.

A still further object of the present invention is to remove the detrimental biomass by heating the water containing such biomass to a pasteurizing temperature.

Another object of the present invention is to provide a control system which may control the system according to given parameters and also, monitoring and registering such parameters, with a possibility of reporting for example to the authorities. Such parameters may be time and date; location, for example based on GPS; volume of water processed for thermal treatment; temperature of the water taken in for thermal treatment; treatment temperature according to approved laboratory tests; tank location for treated water; tank location for water taken in for treatment by circulation for example several times; volume of treated, cleaned water pumped to sea, time and date for such pumping to sea and also the location, based on GPS.

Yet another object of the present invention is to provide a method and a system wherein the water to be treated may be re-circulated several times through the thermal heating system prior to being stored in a clean tank or pumped to sea, until a satisfactory water quality, satisfying the required criteria, is obtained.

According to the present invention, the water to be treated is pumped through a primary heat exchanger where the water is pre-heated and then through a secondary heat exchanger where the water is further heated, the secondary heat exchanger being heated by thermal fluid from a central heating system primarily heated by heat recovered from different type of heat generating equipment and also possibly by fuel and/or electricity in cases where the heat recovered from the heat generating systems is not sufficient to treat the water in a sufficient manner.

The water to be treated may for example be ballast water and/or bacterially or organically contaminated water. Further, the water to be treated may preferably be heated to a temperature above the pasteurization temperature.

According to one embodiment, the water to be treated passes through a slow flow unit (14) at a low flow rate, enabling the water to be treated to be kept at the required pasteurization temperature for a specific period of time.

Further, the water to be treated may be circulated back through the primary heat exchanger in order to extract heat from the treated water to warm up the contaminated water to be treated and by cooling down treated water before storing to tank or discharged to sea, in order to avoid tear and wear in the ship system, caused by high temperature.

According to one option, the treated water is pumped back to another one or more storage tanks onboard the vessel, such tank containing cleaned water only. Only cleaned water from the tank(s) containing clean water may preferably be discharged to sea.

It should be appreciated that the heating process of the water to be cleaned is performed while the vessel sails in a ballast condition.

Further, according to another embodiment, the heating process and the control of water flow through the heat exchangers and “slow flow unit” are automatically controlled by a control system.

It should also be appreciated that the system, i.e. the primary and secondary heat exchangers, the pump(s), the piping and valve system etc. may be configured in such way that it is possible to:
heat and pasteurize water pumped in from the sea or delivered as part of the transporting medium for transporting living aquatic bio mass;
when pumping water from one or more tanks onboard the vessel to a second group of one or more tanks onboard;
prior to pumping water from a tank onboard directly to sea, so that the water pumped to the sea is pasteurized and cleaned; and/or
by re-circulating the water several times through the heat exchanging system, one by one, so as to secure that the water is heated to a sufficiently high temperature to achieve the intended cleaning and/or pasteurizing effect.

The system according to the invention for treating water on board a vessel before discharging such water to the sea comprises a ballast water tank, one or more pumps and a piping and valve system for transport of the water to be treated. In addition the system comprises a first heat exchanger, a second heat exchanger, a slow flow unit for maintaining a required water temperature for a prolonged period of time and a pipe system for either discharging treated water to sea or to one or more second tanks. The piping system is configured in such way that the heated water from the secondary heat exchanger is further heated in the slow flow unit, such heated water passing through the primary heat exchanger for initial heating of the water to be treated.

The second tank(s) may preferably be configured to store the heated, pasteurized water for reuse or pumping overboard. Further, the “slow flow unit” is provided with an integrated heating element, so as to enable maintaining a temperature at or above the pasteurizing temperature for a prolonged period.

On major advantage with the method and system according to the invention resides in that in general no additional fuel or energy is required or must be provided in excess of energy and heat produce by other systems onboard, such energy or heat being of a type which otherwise would have been lost or discharged to the sea.

Another advantage is that the system can be operated at a variable temperature and varying pasteurizing time, depending on available energy and sailing time from port to port. The temperature and pasteurizing time may be logged in the control system for documentation upon request from authorities or others.

### SHORT DESCRIPTION OF THE DRAWINGS

In the following an embodiment of the invention will be described in more detail, referring to the drawings, where:

FIG. 1 shows schematically a flow diagram of the water treatment system according to the present invention, also indicating the direction of flow through the various pipes and units of the water treatment system;

FIG. 2 shows schematically a flow diagram of the water treatment system according to the invention, showing direct pumping of water to sea without pasteurization;

FIG. 3 shows schematically a flow diagram of the water treatment system according to the invention, showing recirculation for heating during start of the system; and

FIG. 4 shows schematically a flow diagram of the water treatment system according to the invention during normal operation.

### DETAILED DESCRIPTION OF THE INVENTION

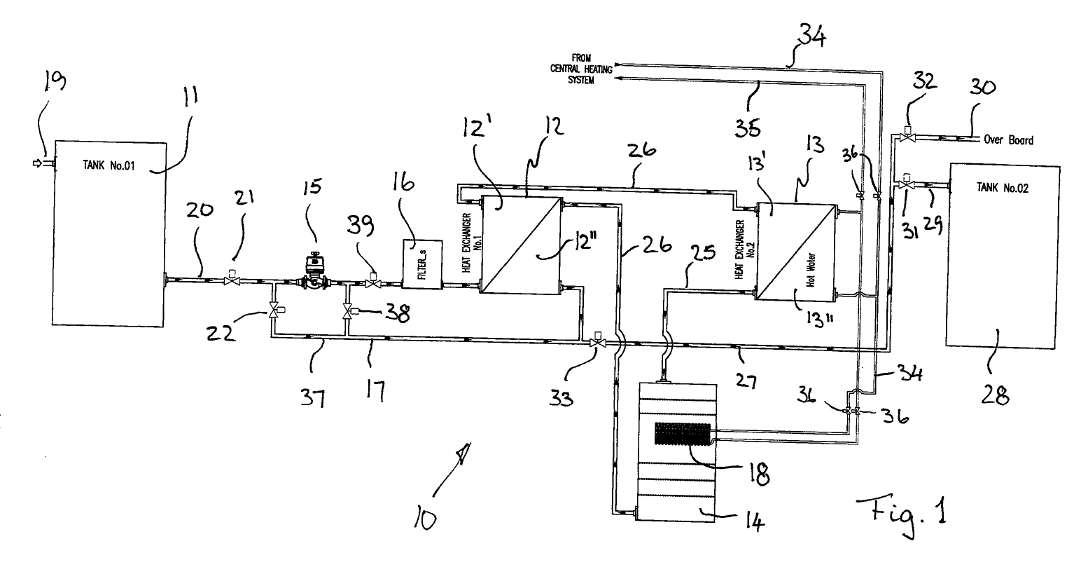

FIG. 1 shows schematically a flow diagram of the water treatment system 10 according to the present invention. The system 10 is intended for sterilizing different types of waste water and ballast water, based on a pasteurization method. The water to be treated is pumped from one contaminated tank 11, hereafter denoted as the first tank 1, or directly from sea, through a heat receiving section 12′ of a primary heat exchanger 12 where the contaminated water is heated and thereupon through a heat receiving section 13′ of a second heat exchanger 13 where the water is heated even further to a temperature above the pasteurization temperature. Water may be supplied to the first tank 11, for example from the sea, through an inlet. The secondary heat exchanger 13 is heated by supplying thermal fluid delivered to a heat delivery section 13″ of the secondary heat exchanger 13 from the central heating system (not shown). The thermal medium delivering heat to the heat delivery section 13″ may for example be heated by thermal energy is supplied either/or by fuel or electricity and/or waste heat recovered from different types of heat generating equipment onboard a vessel, such as the cooling system and exhaust gas system for the propulsion machinery or the like.

The water to be treated is, after being heated to a specific pasteurizing temperature in the secondary heat exchanger 13, flow through a “slow flow unit” 14, enabling the contaminated water to be kept at a specific pasteurizing temperature for a specific time, thermal energy being supplied to said “slow flow init” 14 for example from said central heating unit through an integrated heating element 18.

From the “slow flow unit” 14 the pasteurized water is passed through a heat delivery section 12″ of the primary heat exchanger 12, cooling down the pasteurized water and “pre-heating the contaminated water entering the primary heat exchanger 12, whereupon the pasteurized water is pumped to a second, clean tank for storage, or pumped over board, as the case may be. When the pasteurized water no longer is needed, for example du to de-ballasting, the clean water is pumped to sea. The preheating of the contaminated water in the primary heat exchanger 12 will reduce the energy consumption to a minimum. If there is a surplus of heated thermal medium in the system, such pasteurizing process will virtually be free, since such surplus of thermal medium otherwise would be discharged directly to sea.

The contaminated water from the first tank 11 is pumped through the system by means of a pump 15. Upstream of the pump 15 a filter 16 may preferably be arranged, so as to filter out larger particles or larger living biomass, so as to prevent clogging or growing in the system. The pump 15 is provided with a by-pass line 37 also comprising a first valve 22 and a second valve 38 to allow continuous circulation through the pump 15. Downstream of the pump 15 and upstream of the filter 16, the system may be provided with a bypass-line 17, by-passing the entire pasteurizing system, allowing water from the first tank to be pumped over board, directly to sea. Further a valve 39 is arranged downstream the pump 15 and upstream the filter 16 to enable running the by-pass line 17. This may for example be the case where the vessel is sailing in local waters where possible living biomass in the ballast water will not cause any harm to the local living biomass in the surrounding sea. The by-pass line 17 is also for recirculation of the water in the system during start period in order to obtain specific pasteurizing temperature before storing to tank or discharging to sea.

As shown in FIG. 1, the system is provided with an associated piping system and a number of valves. Water, such as contaminated water or ballast water is supplied to the first tank 11 through a supply line 19. Contaminated water is discharged from the first tank 11 via the filter 16 and the pump 15 to the primary heat exchanger 12 through a discharge pipe 20. A valve 21 is arranged in the discharge line 20 upstream the by-pass line 17. Further, the by-pass line 17 is provided with a valve 22, opening or closing the by-pass line 17 as the case may be. Correspondingly, the discharge pipe 20 is also provided with a valve 39 downstream the branch of the by-pass line 17 and upstream the filter 16, so as either to pump water from the tank 11 to the sea or through the pasteurizing plant according top the present invention. Pre-heated water is leaving the heat receiving side 12′ of the primary heat exchanger 12 through a discharge pipe 26 to the inlet of the heat receiving side 13′ of the secondary heat exchanger 13 where water is heated up to a pasteurizing temperature, whereupon the hot water is pumped to the “slow flow unit” 14 through a pipe line 25 where the pasteurizing temperature is maintained for an adequate period of time. From the outlet of the slow flow init 14 water is circulated to the heat producing side 12″ of the primary heat exchanger 12 through a pipeline 26, heating up the contaminated water from the first tank, while the pasteurized water from the slow flow unit 14 is cooled down. From the heat providing side 12″ of the primary heat exchanger 12, water is pumped through a discharge pipe 27, either over board or to the second tank. To enable such alternative, the inlet pipe 29 to the second tank 28 and the discharge outlet 30 to sea are provided with valves 31 and 32. through the pipeline 27. A valve 33 may be arranged in the discharge line 27 from the primary heat exchanger 12, downstream the connection point with the by-pass line 17.

Hot water is circulated from a central heating station (not shown) through a supply line 34 to the heat providing side 13″ of the secondary heat exchanger 13 and/or to the integrated heating element 18 in the slow flow unit 14 and circulated back to the central heating system (not shown) through the return line 35. The lines 34,35 are provided with valves 36 for controlling the circulation of thermal medium through the system to and from the central heating system.

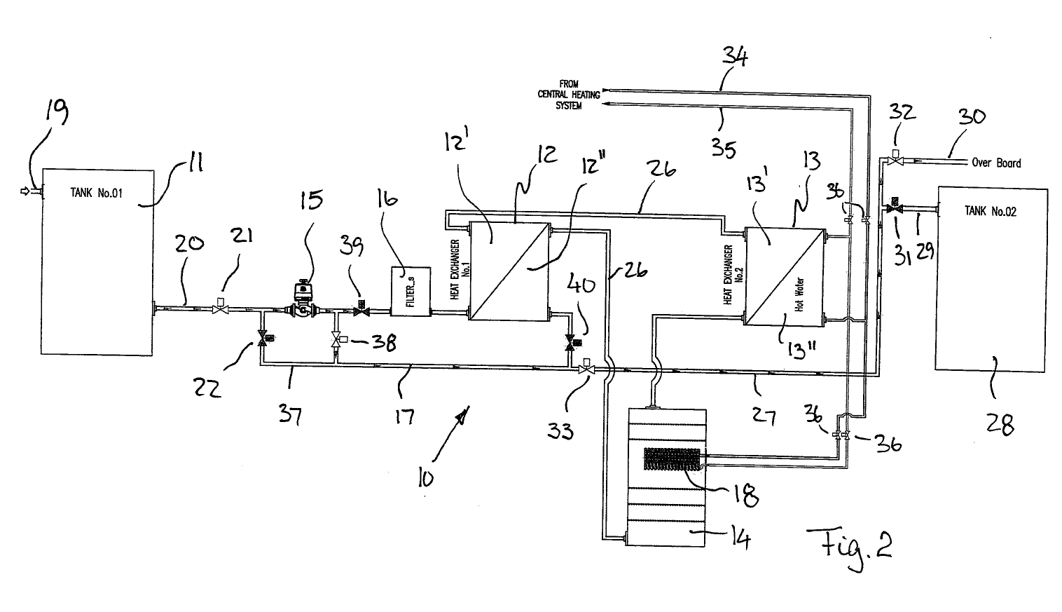

FIG. 2 shows schematically a flow diagram of the water treatment system 10 according to the invention, showing direct pumping of water to sea without pasteurization. The arrows in the lines indicate the flow direction of the pumped water. As indicated in FIG. 2, the valves being filled in with black ink are closed, while the remaining valves being open. In order to pump water directly to sea the pump 15 is pumping water from the first tank 11 through the line 20 with the valves 21 and 28 being open, while valves 22 and 39 are closed. The water is then pumped through line 17 through the open valve 33, while the valve 40 to the heat delivery side 12″ of the primary heat exchanger 12 is closed. Valve 31 is closed while valve 32 is open, allowing the water to be discharged direct to sea.

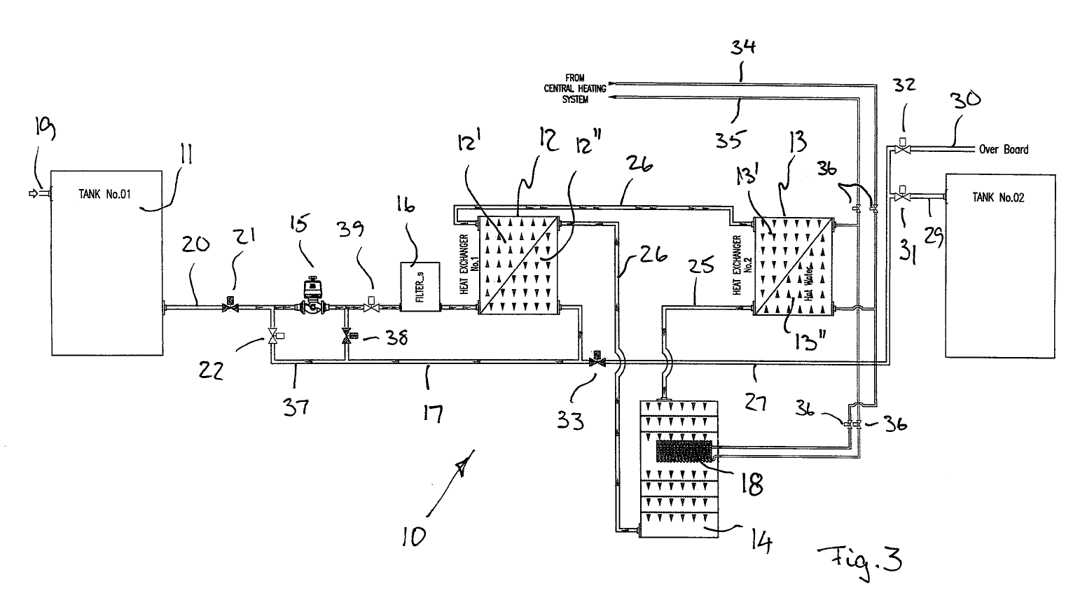

FIG. 3 shows schematically a flow diagram of the water treatment system 10 according to the invention, showing recirculation of heated water for heating during start of the system 10. The arrows in the various lines show direction of flow, and as for FIG. 2, there i no flow in lines not marked with arrows. Further, valves filled with black ink are closed while the other valves are open or idle. The pump 21 is closed the pump 15 circulates water through the line 17,37 the valves 22,39 being open, while the valves 38 and 33 being closed. According to this stage water is circulated through the two heat exchangers 12,13 and being heated in the slow flow unit 14 due to supplied heat energy to the heater 18. Water is circulated until the temperature of the water leaving the heat receiving section 13′ is at the required pasteurizing temperature.

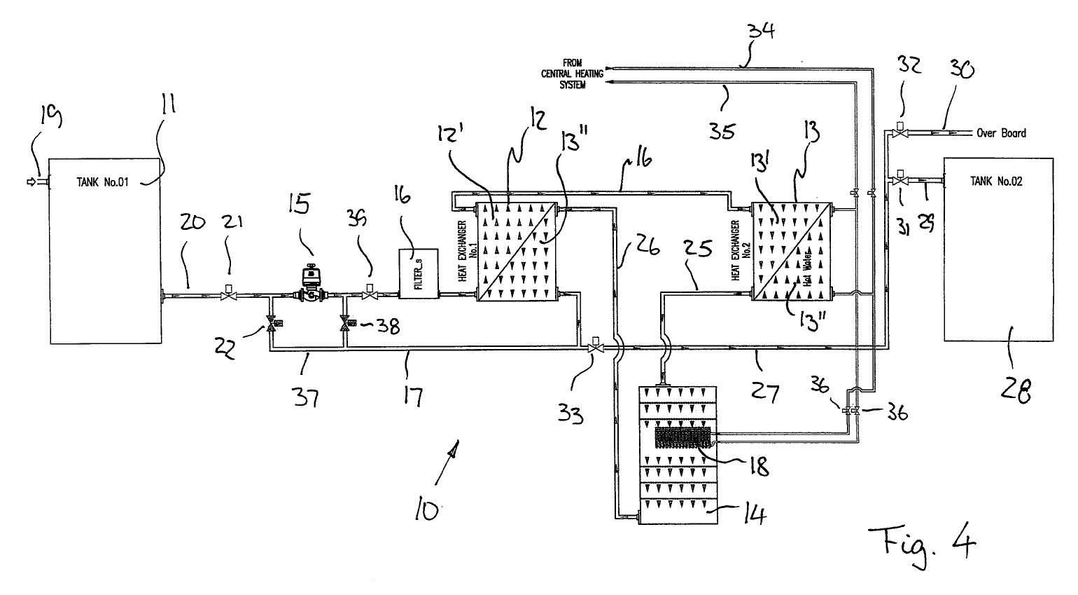

FIG. 4 shows schematically a flow diagram of the water treatment system 10 according to the invention during normal operation of the system 10. Again the direction of flow is indicated by the arrows in the various lines, while valves filled with black ink are closed. The remaining valves are open. Water is pumped from the tank 11 by the pump 15 through the line 20, the valves 21 and 39 being open. The water is then pumped through the filter 16 and into the heat receiving section 12′ of the primary heat exchanger 12. From this section 12′ the partly heated water is pumped through the line 16 into the heat receiving section 13′ of the secondary heat exchanger 13. From the secondary heat exchanger 13, water is pumped through the slow flow unit 14 where it is heated by heat supplied from the central heating system and then into the heat delivery section 12″ of the primary heat exchanger 12 and thereupon out and through the open valve 33 and the line 27 either to the second tank 28 through the line 29 and valve 31 or to sea through line 30 and valve 32 as the case may be.

Energy is delivered to the system in the form of hot water from a central heating system through a line 32 both the heat delivery section 13″ of the secondary heat exchanger 13 and to the heater 18 inside in the slow flow unit 14. Water is the circulated back to the central heating unit for re-heating. According to one embodiment, the water to be pasteurized is first heated

The system according to the present invention is automatically controlled and monitored by a control system (not shown) and can be interfaced to the main computer system (IAS). Safety control system and system for manual control is standard features. The control system is type approved in the major class society. For such purposes the system may be provided with temperature and pressure gauges, communicating with the control system allowing automatic control, while the various valves may be remote controlled. A control cabinet (not shown) for the water treatment system may be used for such purpose, comprising for example a 6.5″ touch screen, showing mimic diagrams in accordance with the system layout; having user interface for system operations; enabling manual and/or automatic control of the temperatures; and also including alarm display and having an interface to the IAS.

The heat exchangers are in addition provided with instrumentation for automatic control of flow rate through the system and of the temperature.

The main circulation pumps may comprise two equal pumps for example mounted on skids, one running and on stand-by. Also the pumps are instrumented both for manual and/or automatic control, so as to enable adjustment of the pumping rate, the pumps preferably being controlled from the remote control system.

It should be appreciated that the system also contains piping, cabling and accessories not shown, such as manually operated valves temperature and pressure gauges, flow meters, means for time control etc.

1. Method for treating contaminated water on board a vessel before discharging such water to the sea,
wherein the improvement comprise that the water to be treated is pumped through a primary heat exchanger (12) where the water is pre-heated and then through a secondary heat exchanger (13) where the water is further heated, the secondary heat exchanger (13) being heated by thermal fluid from a central heating system heated at least in part by heat recovered from a different type of heat generating equipment of the vessel.

2. Method according to claim 1, wherein the water to be treated is ballast water and/or bacterially or organically contaminated water.

3. Method according to claim 2, wherein the water to be treated is heated to a temperature above the pasteurization temperature of the contaminants.

4. Method according to claim 1, wherein the water to be treated passes from the secondary heat exchanger through a slow flow until (14) at a low flow rate, enabling the water to be treated to be kept at a pasteurization temperature of the contaminants for a specific period of time.

5. Method according to claim 4, wherein the water to be treated is circulated from the secondary heat exchanger back through the primary heat exchanger (12) in order to extract heat from the treated water to pre-heat the contaminated water to be treated and to cool the treated water before storing to tank or discharged to sea.

6. Method according to claim 1, wherein the treated water is pumped back to another one or more a storage tank (28) onboard the vessel, such tank (28) containing treated water only.

7. Method according to claim 6, wherein no contaminated water is discharged to the sea and only treated water from tank containing treated water is discharged to sea.

8. Method according to claim 1, wherein the method is performed while the vessel sails in a ballast condition.

9. Method according to claim 4, wherein
the water to be treated is circulated from the secondary heat exchanger and slow flow tank back through the primary heat exchanger (12) in order to extract heat from the treated water to pre-heat the contaminated water to be treated and to cool the treated water before storing to tank or discharged to sea; and
the heating of and the water flow through the heat exchangers (12, 13) and slow flow unit (14) are automatically controlled by a control system.

10. Method according to claim 1, wherein water to be treated is re-circulated through the heat exchangers more than once.

11. System for treating water on board a vessel before discharging such water to the sea, comprising a ballast water tank (11), one or more pumps (15) and a piping and valve system for transport of the water to be treated, wherein the improvement comprises:
a first heat exchanger (12), a second heat exchanger (13), a slow flow unit (14) for maintaining a target water treatment temperature for a prolonged period of time; and
a pipe system for either discharging treated water to sea or to one or more storage tanks (28), wherein the piping system is configured in such way that the heated water from the secondary heat exchanger (13) is further heated in the slow flow unit (18), such heated water passing through the primary heat exchanger (12) for initial heating of the water to be treated.

12. System according to claim 11, wherein the storage tank (28) is configured to store the treated water for reuse or pumping overboard.

13. System according to claim 11, wherein the slow flow unit (14) is provided with an integrated heating element (18), so as to enable maintaining a temperature at or above a pasteurizing temperature for a specific, prolonged period.

14. Method for treating contaminated water on board a vessel that includes an internal system where thermal fluid is heated, comprising:
pre-heating the contaminated water through a primary heat exchanger (12) in the vessel;
further heating the pre-heated water in a secondary heat exchanger (13) in the vessel to a temperature that is above a threshold cleaning temperature, using thermal fluid from the internal system of the vessel; and
directly or indirectly discharging the further heated water from the vessel.

15. The method according to claim 14, wherein the pre-heated water is heated in the secondary heat exchanger to a temperature above a contaminant pasteurization temperature.

16. The method according to claim 14, wherein the internal system is one of the group consisting of a vessel engine system, a fuel combustion system, and an electric heating system.

17. The method according to claim 14, wherein at least some of the water from the secondary heat exchanger provides a source of heat to the primary heat exchanger, before discharge from the vessel.

18. The method according to claim 14, wherein the further heated water from the secondary heat exchanger is delivered to a temporary holding tank (14) where it held at a temperature above the threshold cleaning temperature for a predetermined period of time.

19. The method according to claim 15, wherein
the internal system includes hot coolant (34) from a vessel engine;
the further heated water from the secondary heat exchanger is delivered to a temporary holding tank (14) where it is held at a temperature above the threshold cleaning temperature for a predetermined period; and
water from the temporary holding tank provides a source of heat to the primary heat exchanger, before discharge from the vessel.
